(19) United States
(12) Patent Application Publication
(10) Pub. No.: US 2012/0223803 A1
(43) Pub. Date: Sep. 6, 2012

(54) THERMAL OVERLOAD PROTECTION APPARATUS

(75) Inventors: Martin Striewe, Horn-Bad Meinberg (DE); Friedrich-Eckhard Brand, Barntrup (DE); Joachim Wosgien, Loehne (DE)

(73) Assignee: PHOENIX CONTACT GMBH & CO. KG, Blomberg (DE)

(21) Appl. No.: 13/508,755

(22) PCT Filed: Nov. 5, 2010
(86) PCT No.: PCT/EP2010/006749

§ 371 Date: May 9, 2012

(30) Foreign Application Priority Data
Nov. 10, 2009 (DE) 10 2009 052 400.2

(51) Int. Cl. H01H 37/76

(52) U.S. Cl. 337/416

(57) ABSTRACT

A thermal overload protection device includes a first and a second current-carrying element which are electrically connected to one another via at least one soldered joint that is configured to melt in an event of an overload. At least one of the current-carrying elements is an inherently resilient current-carrying element which, via the at least one soldered joint, is kept in a first form corresponding to at least one of a non-stable state and a metastable state of the inherently resilient current-carrying element. The inherently resilient current-carrying element is deformable into a second form corresponding to a stable state of the inherently resilient current-carrying element via the at least one soldered joint melting. The first and second current-carrying elements are electrically disconnected from one another with the inherently resilient current-carrying element in the second form.

### CROSS-REFERENCE TO PRIOR APPLICATIONS

This application is a U.S. National Phase application under 35 U.S.C. §371 of International Application No. PCT/EP2010/006749, filed on Nov. 5, 2010, and claims benefit to German Patent Application No. DE 10 2009 052 400.2, filed on Nov. 10, 2009. The International Application was published in German on May 19, 2011 as WO 2011/057742 under PCT Article 21(2).

### FIELD

The invention relates to a thermal overload protection device, in particular for an overvoltage protection means, which comprises two current-carrying elements which are electrically connected by means of at least one soldered joint which melts in the event of an overload.

### BACKGROUND

An overload protection device is, for example, known as a current overload protection device. For disconnecting an electrical connection in the event of a thermal overload, a compression spring is arranged between the two current-carrying elements, which are electrically connected by a soldered joint, and presses the two current-carrying elements apart after the soldered joint melts. However, in this case at least one of the current-carrying elements has to be electrically insulated from the compression spring.

Corresponding overload protection devices, for example having spring-actuated sliders, are also used in particular as thermal disconnection elements for overvoltage protection means, a varistor of the overvoltage protection means electrically disconnecting the path of the current to be protected by means of the thermal disconnection elements in the event of an overvoltage. However, disconnection of the current-carrying elements occurs at a relatively low speed in this case. Overall, this leads to a low switching capacity of an overload protection device of this type, in particular in the case of direct current circuits, that is to say DC applications.

### SUMMARY

In an embodiment, the present invention provides a thermal overload protection device including a first and a second current-carrying element which are electrically connected to one another via at least one soldered joint that is configured to melt in an event of an overload. At least one of the current-carrying elements is an inherently resilient current-carrying element which, via the at least one soldered joint, is kept in a first form corresponding to at least one of a non-stable state and a metastable state of the inherently resilient current-carrying element. The inherently resilient current-carrying element is deformable into a second form corresponding to a stable state of the inherently resilient current-carrying element via the at least one soldered joint melting. The first and second current-carrying elements are electrically disconnected from one another when the inherently resilient current-carrying element is in the second form.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective sectional view of a configuration of the thermal overload protection device according to an embodiment of the invention;

FIG. 2 is the cross-section along line A-A shown in FIG. 3 through the thermal overload protection device of FIG. 1; and

FIG. 3 is a plan view of the thermal overload protection device of FIG. 1.

### DETAILED DESCRIPTION

In an embodiment, the invention provides a simple and cost-effective overload protection device which rapidly and reliably disconnects the current-carrying elements from one another in the event of a thermal overload.

In an embodiment, at least one of the current-carrying elements is an inherently resilient current-carrying element which, by means of the soldered joint, is kept in a first form which is associated with a non-stable state or a metastable state of this current-carrying element, and which, by means of the soldered joint melting, is deformed into a second form associated with a stable state of this current-carrying element, in which second form the two current-carrying elements are electrically disconnected from one another. The thermal overload protection device is a type of fuse which, despite the simple construction and low number of components thereof, ensures a well-defined overall state of the device in the “open switch state”. The solder of the soldered joint is preferably a soft solder having a melting temperature of from 150° C. to 250° C., in particular a soft solder having a melting temperature of from 180° C. to 220° C.

Preferably, the inherently resilient first current-carrying element has a stable state and a metastable state having respectively corresponding forms. During the manufacturing and production process of the overload protection device, the first current-carrying element is put into the first form corresponding to the metastable state or close to the first form corresponding to the metastable state, and is additionally stabilised there by means of the soldered joint. If heating of the soldered joint occurs during operation of the overload protection device which causes the soldered joint to melt, the first current-carrying element abruptly deforms back into the second form corresponding to the stable state. This second form is such that the two current-carrying elements are completely electrically disconnected from one another. In this case, the other (second) current-carrying element can be, for example, a completely rigid current-carrying element.

Preferably, the one current-carrying element is formed in one piece. The resilience of this current-carrying element results from the internal structure of this element.

It is provided in an embodiment that the one current-carrying element and also the other current-carrying element are formed as inherently resilient current-carrying elements, each having a stable state and a non-stable or metastable state. In the case of an overload protection device having current-carrying elements of this type, which are arranged symmetrically, for example, the isolating distance can be considerably increased.

The overload protection device is suitable in particular for application in an overvoltage protection means, the thermal overload protection device being connected in series for example to an overvoltage-sensitive component, preferably a varistor, of the overvoltage protection means, and the component electrically disconnecting the path of the current to be protected by means of the thermal overload protection device in the event of an overvoltage.

According to a preferred development of the invention, it is provided that the one current-carrying element is formed as a metal spring. Metal springs have sufficient inherent resilience and can be formed as compression springs, tension springs, spiral springs and/or torsion springs of various shapes.

According to a further preferred development of the invention, the one current-carrying element is formed as a substantially leaf-spring-like and/or cap-shaped clicker element. In this case, in ordinary language the term “clicker” is understood to mean a spring which consists of a strip of spring steel. The steel is preferably characterised in such a way that it has a stable and a metastable state. By the application of forces in the stable state, it is bent until it suddenly springs into the metastable state due to buckling. A mechanism which is similar or based on a comparable principle is used in the clicker element.

According to a further preferred development of the invention, it is provided that, in the radial outer region thereof, the clicker element is connected in at least one circumferential portion, in particular over the entire circumference, to a surface of a base element which bears the clicker element. In this case, the clicker element is preferably a dome-shaped or cap-shaped clicker element. In this case it is provided in particular that the clicker element is configured so as to be rotationally symmetrical.

According to an advantageous embodiment of the invention, it is provided that the radial outer region of the clicker element is formed as a flattened rim. An extensive connection to the surface of the base element can be ensured by means of the rim-like outer region.

According to a preferred development of the invention, it is provided that a hollow space formed between the clicker element and the base element has, at least in part, a predetermined charge for increasing the electrical strength between the disconnected current-carrying elements. The electrical strength of the resulting isolating distance between the disconnected current-carrying elements is relatively low in a normal atmosphere. To prevent a current breakdown and/or a leakage current, the hollow space is therefore filled with a charge which increases the electrical strength in comparison with the air. This charge can be in the form of a gas, a liquid and/or, at least at temperatures below the melting temperature of the solder, a solid.

According to a further preferred development of the invention, it is provided that the predetermined charge comprises a quenching gas, an oil and/or a wax. The electrical strength, but also the switching behaviour, is considerably improved by these charges. The charge is, for example, a gas charge. Instead of a gas charge of this type or in addition thereto, complete or partial filling of the hollow space with an oil or a wax is advantageous, a wax being both particularly simple to process in terms of manufacturing and already being a liquid at a temperature at which the soldered joint melts.

When charging with a liquid or with a wax, by corresponding configuration of the current-carrying elements it can be achieved that, at the point of electrical disconnection of the two current-carrying elements, the actual contact point between the current-carrying elements having the soldered joint is positioned below the liquid level independently of the orientation or position of the overload protection device. Therefore the resulting isolating distance is filled with the electrically essentially more solid charge, that is to say the liquid dielectric, and this results in a significantly improved DC switching capacity.

It is preferably provided that the other current-carrying element is formed as a part of an electrical contact means arranged at least in part on the surface of the base element. In this case, the contact means projects into the hollow space by such a distance that, in the case of an existing soldered joint, the one current-carrying element is in the first form corresponding to the metastable state or is at least close to the first form corresponding to the metastable state.

Finally, it is advantageously provided that the base element is formed as a conductor line carrier which contacts the clicker element in the outer region, and is formed in particular as a printed circuit board. In this case, at least one conductor line of the conductor line carrier contacts the one current-carrying element which is preferably formed as a clicker element and at least one other conductor line contacts the other current-carrying element. This can, for example, be formed as a simple metal body (metal block) which is, for example, attached to a conductor line structure of the conductor line carrier by means of a soldered joint using a solder having a high melting point and is therefore electrically contacted.

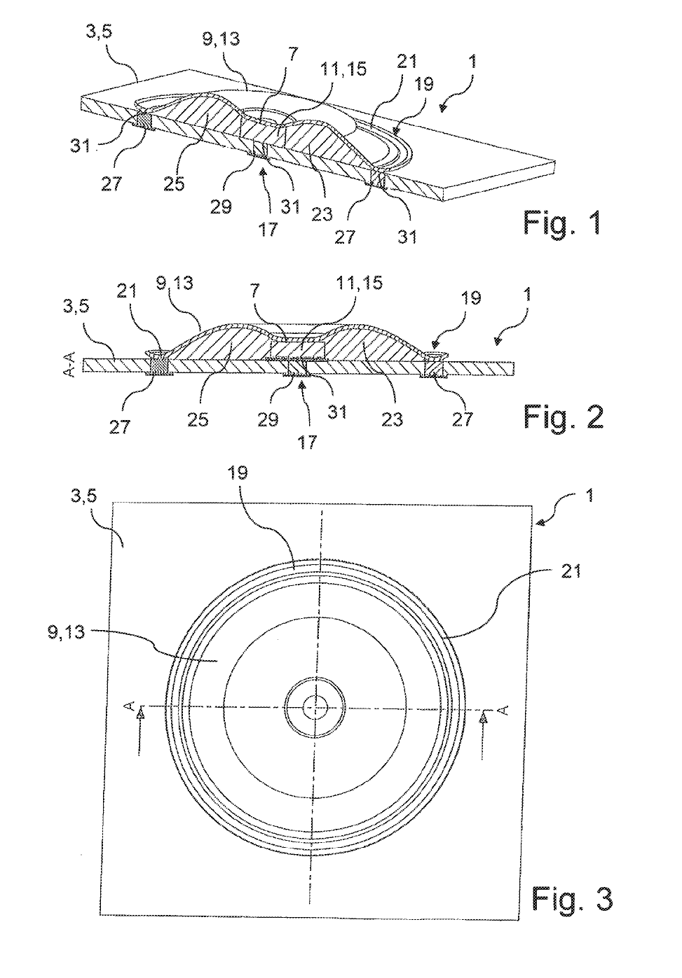

FIGS. 1 to 3 show an embodiment of the thermal overload protection device 1 comprising two current-carrying elements 9, 11 arranged on a base element 5, which is formed as a conductor line carrier 3, and electrically connected by means of least one soldered joint 7 which melts in the event of an overload. The first current-carrying element 9 is an inherently resilient current-carrying element 9 formed as a clicker element 13 and the other (second) current-carrying element 11 is a current-carrying element 11 configured as a rigid metal body 15 of a contact means 17 and is arranged centrally on the base element 5 below the first current-carrying element 9.

The inherently resilient first current-carrying element 9 has a metastable state having an associated first form and a stable state having an associated second form. The two current-carrying elements 9, 11 are electrically conductively connected by the soldered joint 7 in the non-triggered overall state of the overload protection device 1. In this non-triggered overall state, the one current-carrying element 9 is kept in the first form associated with the metastable state. By the melting of the soldered joint, that is to say by the triggering of the overload protection device 1, this current-carrying element 9 deforms into the second form associated with the stable state, the two current-carrying elements 9, 11 being electrically disconnected from one another.

The clicker element 13, formed so as to be cap-shaped and rotationally symmetrical, is connected in its radial outer region 19 to a surface of the base element 5 over the entire circumference. In this case, the radial outer region 19 of the clicker element 13 is formed as a flattened rim 21.

A hollow space 23 formed between the cap-shaped clicker element 13 and the base element 5 is filled at least in part with a charge 25 for increasing the electrical strength between the disconnected current-carrying elements 9, 11, that is to say the clicker element 13 and the metal body 15. This charge 25 is in particular a wax for increasing the electrical strength.

At least one conductor line and/or one feedthrough 27 of the conductor line carrier 3 formed as a printed circuit board contacts the clicker element 12 in the radial outer region 19 thereof and at least one other conductor line and/or feedthrough 29 contacts the other current-carrying element 11. In the example shown in FIGS. 1 to 3, this is a simple metal body (metal block) 15 which is attached and thereby electrically connected to a feedthrough of the conductor line carrier by means of a further soldered joint 31 using a solder having a high melting point. The solder having a high melting point of the further soldered joint 31 has a considerably greater melting temperature in this case than the solder of the soldered joint 7 between the current-carrying elements 9, 11.

The following functions of the overload protection device 1 result: in the event of an overload, the solder arranged between the current-carrying elements 9, 11 melts in such a way that the corresponding soldered joint 7 is released. As a result, the one current-carrying element 9 is no longer kept in the metastable state and the associated first form and “snaps” back into the stable state and the second state connected thereto. By taking on this second state, the two current-carrying elements are, however, electrically disconnected from one another in a clear and stable manner.

Therefore, in a simple, rapid and reproducible manner which can be implemented cost-effectively, an opportunity is provided for improving the switching behaviour and the strength of the isolating distance of overload protection devices, and simultaneously for achieving a significantly improved DC switching capacity.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

LIST OF REFERENCE NUMERALS

1 overload protection device

3 conductor line carrier

5 base element

7 soldered joint

9 one current-carrying element

11 another current-carrying element

13 clicker element

15 metal body

17 contact means

19 radial outer region

21 rim

23 hollow space

25 charge

27 feedthrough

29 feedthrough

31 further soldered joint

1-10. (canceled)

11. A thermal overload protection device comprising:
a first and a second current-carrying element which are electrically connected to one another via at least one soldered joint configured to melt in an event of an overload, at least one of the current-carrying elements being an inherently resilient current-carrying element which, via the at least one soldered joint, is kept in a first form corresponding to at least one of a non-stable state and a metastable state of the inherently resilient current-carrying element, and
wherein the inherently resilient current-carrying element is deformable, via the at least one soldered joint melting, into a second form corresponding to a stable state of the inherently resilient current-carrying element and in which the first and second current-carrying elements are electrically disconnected from one another.

12. The overload protection device according to claim 11, wherein the inherently resilient current-carrying element is a metal spring.

13. The overload protection device according to claim 11, wherein the inherently resilient current-carrying element includes at least one of a substantially leaf-spring-like element and a cap-shaped clicker element.

14. The overload protection device according to claim 13, wherein the inherently resilient current-carrying element is the cap-shaped clicker element which is connected, at least at one circumferential portion in a radial outer region of the cap-shaped clicker element, to a surface of a base element which bears the cap-shaped clicker element.

15. The overload protection device according to claim 13, wherein the inherently resilient current-carrying element is the cap-shaped clicker element which is rotationally symmetric.

16. The overload protection device according to claim 13, wherein the inherently resilient current-carrying element is the cap-shaped clicker element which includes a flattened rim at a radial outer region thereof.

17. The overload protection device according to claim 14, wherein a hollow space is formed between the cap-shaped clicker element and the base element that includes, at least in part, a predetermined charge that increases electrical strength between the first and second current-carrying elements when the first and second current-carrying elements are electrically disconnected from one another.

18. The overload protection device according to claim 17, wherein the predetermined charge includes at least one of a quenching gas, an oil and a wax.

19. The overload protection device according to claim 14, wherein the first current-carrying element is the inherently resilient current-carrying element and the second current-carrying element is formed as a part of a contact device disposed, at least in part, on the surface of the base element.

20. The overload protection device according to claim 14, wherein the base element is a conductor line carrier which contacts the cap-shaped clicker element in the radial outer region.

21. The overload protection device according to claim 11, wherein the inherently resilient current-carrying element is deformable into the second form so as to provide overvoltage protection.
